(19) United States
(12) Patent Application Publication
(10) Pub. No.: US 2003/0093891 A1
(43) Pub. Date: May 22, 2003

(54) Method for manufacturing speaker

(76) Inventor: Kenichi Ajiki, Mie (JP)

Correspondence Address: WENDEROTH, LIND & PONACK, L.L.P., 2033 K STREET N. W., SUITE 800, WASHINGTON, DC, 20006-1021, US

(21) Appl. No.: 10/181,033

(22) PCT Filed: Nov. 13, 2001
(86) PCT No.: PCT/JP01/09906

(30) Foreign Application Priority Data
Nov. 15, 2000 (JP) 2000-347799

(51) Int. Cl. H04R 1/00; H04R 9/06

(52) U.S. Cl. 29/594; 381/403; 381/404

(57) ABSTRACT

A method of manufacturing a loudspeaker comprising: continuously forming diaphragm portions and alignment portions on a band resin film; positioning one of a frame and a protector at an upper die or a lower die; aligning another alignment portion formed on the frame, the protector, the upper or lower die having the film disposed thereon with the alignment portion formed on the film; bonding the frame and the resin film forming the diaphragm; and cutting a diaphragm out of the resin film. The position of bonding the diaphragm to the frame or the protector can be easily determined by aligning the alignment portion formed on the band resin film with another alignment portions provided on the frame, the protector, or the lower or upper die on which the frame or protector is disposed. Further, a conventionally-indispensable ring can be eliminated to reduce the number of components.

### TECHNICAL FIELD

The present invention relates to a method of manufacturing small-sized speakers used in mobile communication equipment and the like.

### BACKGROUND ART

A conventional method of manufacturing a loudspeaker (speaker) will be described with reference to FIG. 7 to FIG. 9 by taking a receiver as an example which is a type of speaker used in mobile communication equipment.

FIG. 7 is a half sectional view of a conventional receiver, and FIG. 8 is an exploded perspective view of the same, and FIG. 9 is a manufacturing flow chart of the same. In FIG. 7 to FIG. 9, the receiver comprises frame 1, yoke 2 bonded to the frame 1, magnet 3 bonded to the internal center of the yoke 2, plate 4 bonded to the top of the magnet 3, voice coil 5 bonded to diaphragm 6, ring 7 bonded to the frame 1 after being bonded to the periphery of the diaphragm 6, protector 8 for protecting the diaphragm 6, and lead wire junction 9 of the voice coil 5 formed in the frame 1. The yoke 2, the magnet 3, and the plate 4 form a magnetic circuit.

The method of manufacturing the receiver is described in the following. A receiver manufacturing method generally comprises a molding process for molding diaphragm 6 out of band resin film by means of a die; a periphery cutting process for cutting the periphery of the diaphragm 6 by means of a high precision cutting die; a ring bonding process for bonding ring 7 to the periphery of diaphragm 6; a first bonding process for bonding the voice coil 5 and the diaphragm 6; an insert molding process for molding a junction component integrated by insert-molding of a magnetic circuit portion formed of the yoke 2, the magnet 3 and the plate 4 into the frame 1 made of resin; a second bonding process for bonding the frame 1 and the junction component by arranging the voice coil 5 in a magnetic gap of the magnetic circuit portion; a soldering process for soldering lead wires of the voice coil 5 to the lead wire junction 9 of the frame 1; and a third bonding process for bonding the protector 8.

However, in the above conventional manufacturing process, the ring 7 is bonded to the periphery of the diaphragm 6 in the ring bonding process, resulting in increase in the number of components used and the man-hours required for assembly. Accordingly, there arises a problem of high manufacturing costs. Particularly, when the diaphragm 6 is 10 μm or less in thickness, the diaphragm 6 is not strong enough and it is difficult to handle the diaphragm 6 in a single unit, and the ring bonding process is indispensable to facilitate the handling of the diaphragm.

The present invention is to address the above problem by providing a speaker manufacturing method which can reduce the production cost of small-sized speakers such as receivers and the like.

### DISCLOSURE OF THE INVENTION

The speaker manufacturing method of the present invention includes the steps of: forming diaphragm portions and alignment portions continuously on a band resin film; disposing a frame or a protector under an upper die or on a lower die; aligning other alignment portions provided on the frame, the protector, and the upper die or the lower die with the alignment portion formed on the resin film; bonding the frame and resin film; and cutting the diaphragm out of the resin film.

Thus, the position of bonding the diaphragm to the frame or protector can be easily determined by aligning another alignment portion provided on the frame, the protector or the lower or upper die with the frame or protector disposed thereon in relation to the alignment portion formed on the band resin film.

Further, it is possible to reduce the number of components used by eliminating the ring that has been conventionally indispensable. According to the present invention, as compared with the prior art, it is not difficult to handle the diaphragm despite the ring being eliminated.

Also, according to the present invention, the voice coil and the frame previously disposed on the lower die can be bonded together to the resin film with a diaphragm formed thereon, and thereby, it is possible to further reduce the man-hours required for assembly.

Further, the post-process in the speaker manufacturing method of the present invention includes the steps of: fixing the magnetic circuit in the frame, fixing the protector in the frame so as to cover a diaphragm or the diaphragm portion, and forming the diaphragm by cutting and separating the diaphragm portion.

According to the present invention, the protector and the magnetic circuit can be very efficiently fixed and bonded by using the band resin film as a base. By using a laser beam for performing the cutting operation, it becomes possible to perform accurate cutting with extreme ease even in a case of a diaphragm having a complicated shape such as a circular, an elliptic, or a racing track shape according to a contour of the diaphragm, the frame or the protector.

### BRIEF DESCRIPTION OF THE DRAWINGS

FIG. 1 is an exploded perspective view showing a receiver in one preferred embodiment of the present invention.

FIG. 2 is a flow chart showing each manufacturing step in the manufacturing method of the present invention.

FIG. 3 is a plan view showing a state of a diaphragm formed in a band sheet.

FIG. 4 is a sectional view for describing the step of bonding a diaphragm to a voice coil and a frame.

FIG. 5 is a sectional view for describing the step of cutting the diaphragm.

FIG. 6 is a sectional view for describing a state of a fixed protector in a modification of the present preferred embodiment.

FIG. 7 is a half sectional front view of a conventional receiver used in a mobile communication device.

FIG. 8 is an exploded perspective view of the conventional receiver.

FIG. 9 is a flow sheet of the conventional receiver.

### DETAILED DESCRIPTION OF THE INVENTION

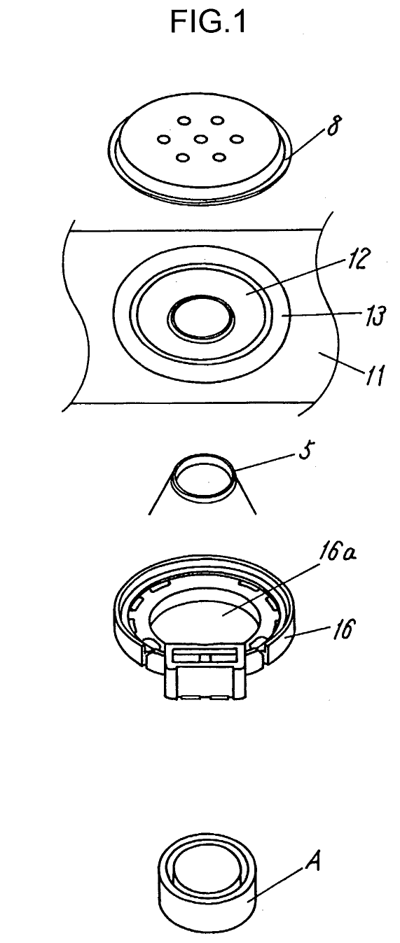

The speaker manufacturing method of the present invention will be described in the following with reference to FIG. 1 through FIG. 6. In the description, the same components as in the prior art are given the same reference numerals, and their description is omitted.

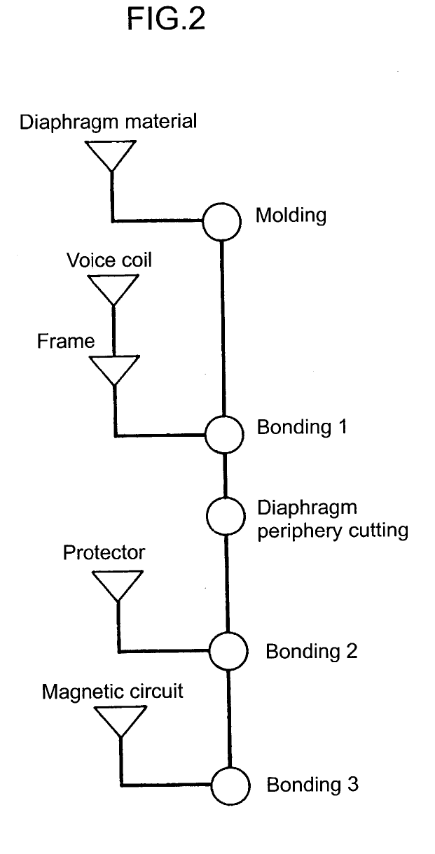

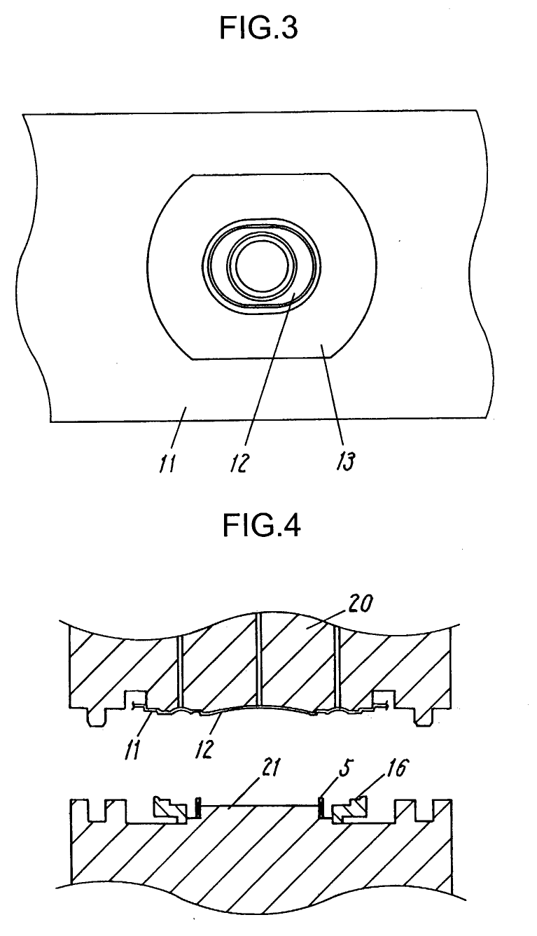

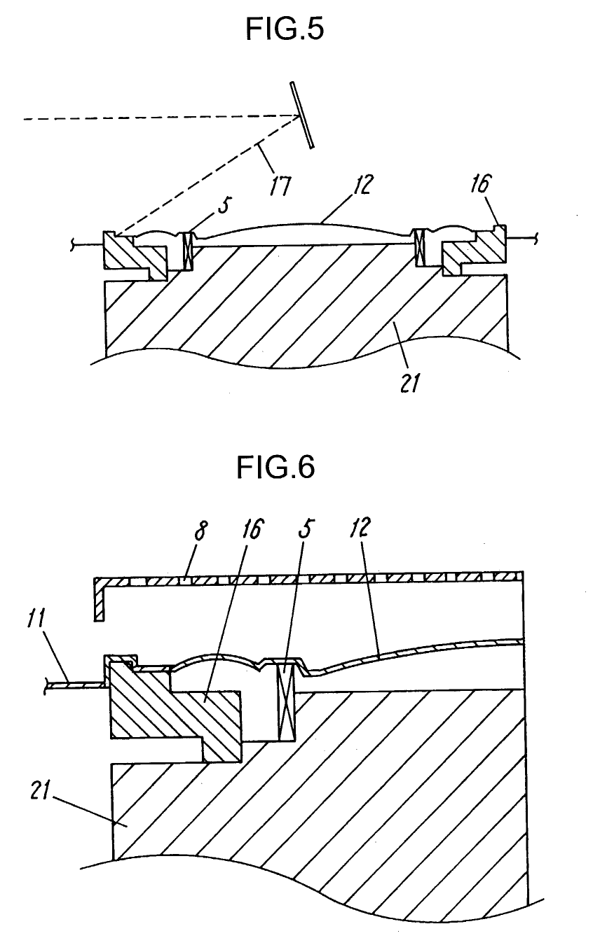

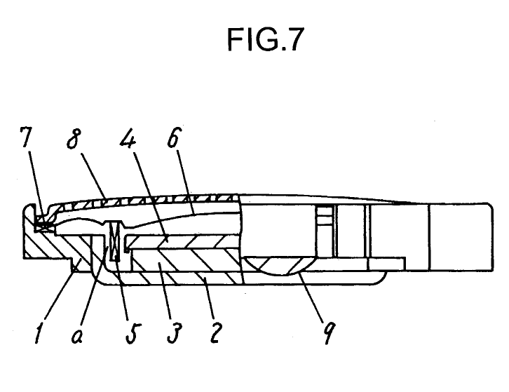

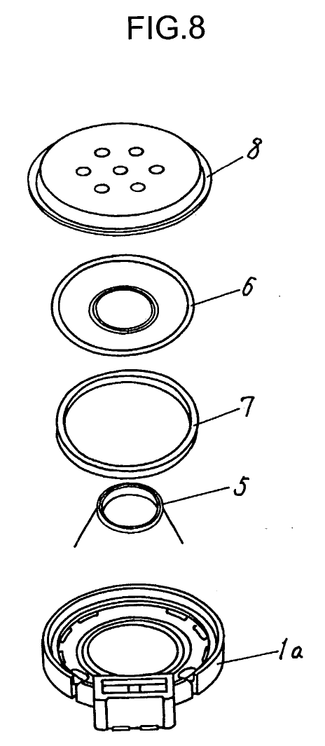

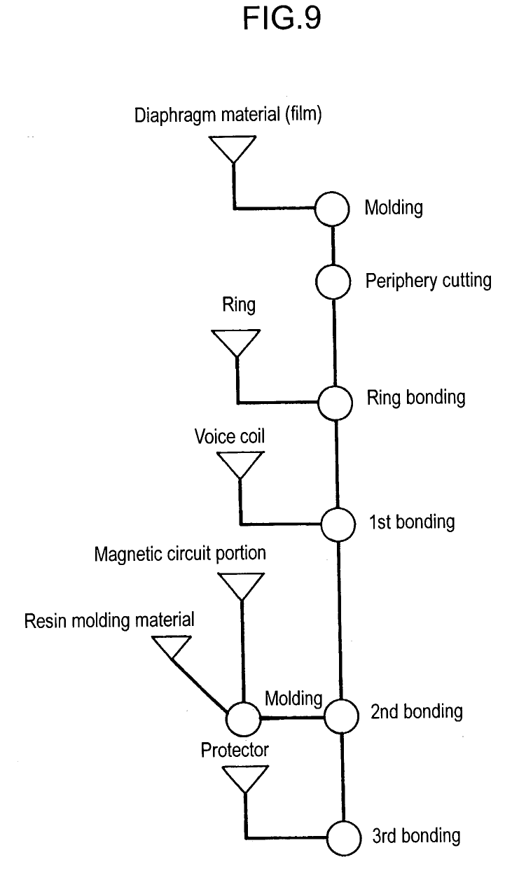

FIG. 1 is an exploded perspective view for describing the speaker manufacturing method in one preferred embodiment of the present invention by taking a receiver, a type of loudspeaker, as an example. FIG. 2 is a flow chart showing each of the manufacturing steps. FIG. 3 is a plan view showing a state of a diaphragm formed on a band sheet. FIG. 4 is a sectional view for describing the step of bonding a diaphragm to a voice coil and a frame. FIG. 5 is a sectional view for describing the step of cutting the diaphragm. FIG. 6 is a sectional view for describing a state of a fixed protector, showing an example of a modification of the present preferred embodiment.

In FIG. 1, firstly, a band resin sheet 11 is finally cut off to form a diaphragm 6. A diaphragm portion 12 and an alignment portion 13 at a periphery of the diaphragm portion 12 are continuously molded on the band resin sheet 11 by means of a molding die (molding process).

Next, as shown in FIG. 4, a voice coil 5 and a frame 16 (FIG. 1) provided with a hole portion 16a for fixing a magnetic circuit A (FIG. 1) at a center are disposed on a lower die 21, and the band resin sheet 11 is aligned by the alignment portion 13 and attached to an upper die 20 by a vacuum.

Subsequently, an adhesive is applied to the voice coil 5 and the frame 16, and then the lower die 21 and the upper die 20 are made to contact to bond the voice coil 5 and the frame 16 in the predetermined position of the band resin sheet 11 (bonding process 1).

Next, as shown in FIG. 4, a periphery of the diaphragm in the band resin sheet 11 with the voice coil 5 and the frame 16 bonded thereon is cut off by a carbon dioxide laser 17 (diaphragm periphery cutting process), thereby making the diaphragm 6 into a composite unit which incorporates the voice coil 5 and the frame 16.

After that, a protector 8 is placed and bonded (bonding process 2) so as to cover the diaphragm 6 that is a composite unit, and further, magnetic circuit A is inserted into the central hole of the frame 16 and is bonded by an adhesive (bonding process 3) to complete a loudspeaker.

As described above, according to the present preferred embodiment, the alignment portion 13 is also formed when the band resin sheet 11 is formed into a diaphragm in the molding process, and the voice coil 5 and the frame 16 are bonded by using the band resin sheet 11 in the bonding process 2. In this way, it is possible to make the ring 7, which has been indispensable, unnecessary, and the diaphragm 6 with the voice coil 5 and the frame 16 bonded thereon can be formed by cutting the diaphragm periphery with the carbon dioxide laser 17 later in the diaphragm periphery cutting process. According to the present invention, the manufacturing method is extremely easy even when the diaphragm 6 is special in shape (elliptic, racing track shape or the like) other than a circular shape. In addition, it brings about such advantage that the periphery cutting and other cutting operations can be automated in accordance with the speaker shape due to the preprogrammed information.

In the description of the above preferred embodiment, the voice coil 5 and the frame 16 are bonded to the band diaphragm 11 by aligning and attaching the alignment portion 13 of band resin sheet 11 to the upper die 20 with the frame 16 and the voice coil 5 positioned on the lower die 21 in the bonding process 1. However, it is also possible that the frame 16 and the voice coil 5 are disposed on the lower die 21, and after applying adhesive thereto, the alignment portion 13 of band resin sheet 11 is aligned and press-bonded on the periphery of the frame 16 by means of the upper die 20. And, it is also possible to provide an alignment portion corresponding to the alignment portion 13 on the lower die 21 for convenience with bonding operation.

Also, in the description of the above preferred embodiment, an example of bonding the band resin sheet 11 to the frame 16 is described, but it is also possible to bond the resin sheet 11 to the protector 8.

In the present preferred embodiment, the diaphragm periphery cutting process is described as a process after the bonding process 1, but it is also preferable to be a process after the bonding process 2 or a process after the bonding process 3.

FIG. 6 is an example of a modification of the present preferred embodiment in which, after bonding the protector 8 to the frame 16 with adhesive, the diaphragm 6 is individually cut out of the resin sheet 11 by means of a laser beam.

In the example of this modification, the diaphragm 6 and the frame 16 can be bonded not only by using adhesive but also by using a mechanical (press-fitting) securement to the protector 8, and as a result, a bonding reliability of the diaphragm 6 and the frame 16 is improved.

As described above, the procedure of each process of the present invention is not limited to the one adopted in the present preferred embodiment.

It is possible to properly change the procedure of other manufacturing processes so far as at least the step of molding the diaphragm portion 12 and alignment portion 13 together on the band resin sheet and the step of aligning and bonding the frame 16 by using the alignment portion 13 are included in the process, and the procedure thereof is within the scope of the present invention.

In the above description, a manufacturing example using a continuous band resin sheet is described to improve the productivity, but it should be noted that the resin sheet may be in a form of single sheet.

Also, described in the above description is a method of bonding main component elements such as the diaphragm, the frame, and the protector with the adhesive, but instead of using adhesive, these component elements may also be bonded by bonding means such as ultrasonic welding, thermal press-bonding, and welding. That is, because most of these component elements that have been recently available are made of resin material, it is possible to employ the bonding methods as mentioned above.

### Industrial Applicability

As described above, the speaker manufacturing method of the present invention is characterized in that resin film is provided with a diaphragm portion and an alignment portion, and a loudspeaker is assembled in accordance with the alignment portion without cutting the diaphragm periphery, and after assembling the speaker, the periphery cutting of the diaphragm portion is performed. According to the present invention, a ring component for holding the diaphragm can be eliminated and it is possible to reduce the man-hours required for assembly and to lower the manufacturing cost.

1. A method of manufacturing a loudspeaker comprising the steps of:
forming a diaphragm portion and an alignment portion on a resin film;
disposing at least one of a frame and a protector on an upper die or beneath a lower die;
aligning other alignment portions provided on said frame, on said protector, on said upper die or on said lower die with said alignment portion on said resin film, said other alignment portions corresponding to said alignment portion on said resin film;
bonding one of said frame and said protector to said resin film; and
cutting a diaphragm out of said resin film.

2. The method of manufacturing a loudspeaker of claim 1, further comprising the steps of:
disposing a voice coil beneath said upper die or on said lower die; and
bonding said voice coil and one of said frame and said protector together on said resin film.

3. The method of manufacturing a loudspeaker of any one of claim 1 or claim 2, further comprising the steps of:
fixing a magnetic circuit having a magnetic gap in which the voice coil is inserted on said frame; and
fixing a protector on said frame so as to cover said diaphragm or said diaphragm portion.

4. The method of manufacturing a loudspeaker of claim 1, wherein a laser beam is employed for cutting said diaphragm portion.

5. The method of manufacturing a loudspeaker of any one of claim 1 or claim 2, wherein said bonding is performed by one of ultrasonic welding, heat press-bonding, and welding.

6. The method of manufacturing a loudspeaker of any one of claim 1 or claim 2, wherein said resin film is a continuous band.
